(19) United States
(12) Patent Application Publication
(10) Pub. No.: US 2007/0223897 A1
(43) Pub. Date: Sep. 27, 2007

(54) METHOD FOR AVOIDING GENERATING SHADOW WHEN TAKING A PICTURE OF AN OBJECT

(76) Inventor: Chih-Hung Kao, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/463,886

(22) Filed: Aug. 10, 2006

(30) Foreign Application Priority Data
Mar. 22, 2006 (TW) 095109911

(51) Int. Cl. G03B 15/02

(52) U.S. Cl. 396/4

(57) ABSTRACT

Before taking a picture for identification, set up a camera, set up a light box in front of the camera, and turn on the light box so as to project light towards the camera. When a person is positioned between the camera and the light box, turn on a flash of the camera and push a shutter button of the camera to take a picture of the person. In this way, no shadow will appear in the developed picture.

### BACKGROUND OF THE INVENTION

1. Field of the Invention

The present invention relates to a method for photographing, and more particularly, to a method for avoiding generating a shadow when taking a picture of an object.

2. Description of the Prior Art

When taking a picture for identification (ID), light on a person's face can be uneven due to facial features. Part of the person's face can be too bright and part too dark. Therefore, a flash is positioned near a camera to project intense light toward the person's face so as to solve the problem of receiving light unevenly. Moreover, the background of an ID photo should typically be only one color. Thus, there is a curtain set behind the person to be photographed. However, when the flash projects intense light toward the person, a shadow can be generated on the curtain, such shadow also appearing in the developed photo.

In order to develop photos without shadows, a flash synchronizer is used for projecting intense light toward the background curtain when the flash operates.

Please refer to FIG. 1, which shows how photographic equipment is arranged based on the prior art. The photographic equipment comprises a camera 10, a flash 12, a flash synchronizer 14, and a background curtain 16. When a person to be photographed is seated, a professional photographer adjusts a lens of the camera 10 to focus on the person. The flash 12 projects intense light toward the person's face when the photographer pushes a shutter button of the camera 10. At the same time, the flash synchronizer 14 projects intense light toward the background curtain 16 so as to eliminate the shadow.

If the camera 10 of FIG. 1 is a point-and-shoot camera, since the point-and-shoot camera cannot detect other light-emitting devices, such as the flash synchronizer 14, exposure might be incorrect. Additionally, the flash synchronizer 14 cannot distinguish a flash of light for eliminating red-eye from a flash of light to be projected on the person's face, resulting in incorrect triggering time for the flash synchronizer 14. Therefore, in order to take an identification picture without shadow, a professional photographer and professional photographic equipment are both required.

However, the photographic equipment of FIG. 1 is very expensive, and requires a large space to arrange the flashes 12, 14. This makes it inconvenient for non-professional photographers, such as an administrative unit of a company, to take identification photos.

### SUMMARY OF THE INVENTION

The claimed invention provides a method for avoiding generating shadow when taking a picture of an object. The method comprises setting up a camera, setting up a light box in front of the camera, turning on the light box, and turning on a flash of the camera and pushing a shutter button of the camera when an objected to be photographed is positioned between the camera and the light box.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows how photographic equipment is arranged based on the prior art.

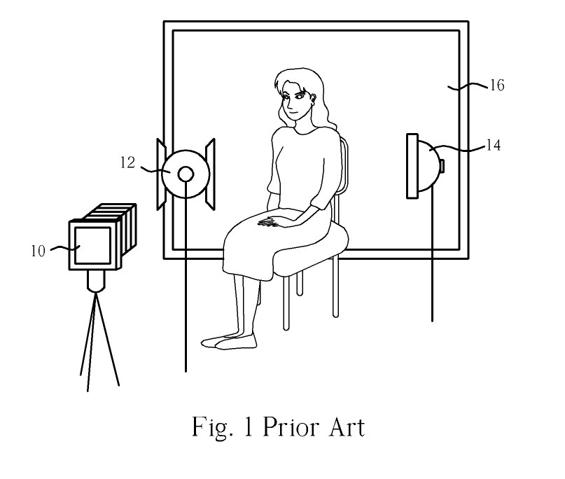

FIG. 2 is a front view of a light box of the present invention.

FIG. 3 is a rear view of a light box of the present invention.

FIG. 4 shows how photographic equipment is arranged based on the present invention.

### DETAILED DESCRIPTION

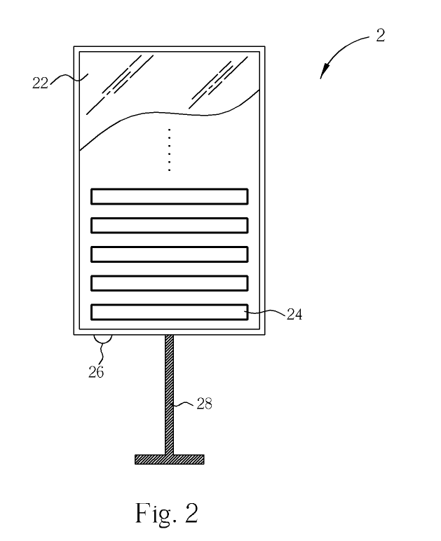

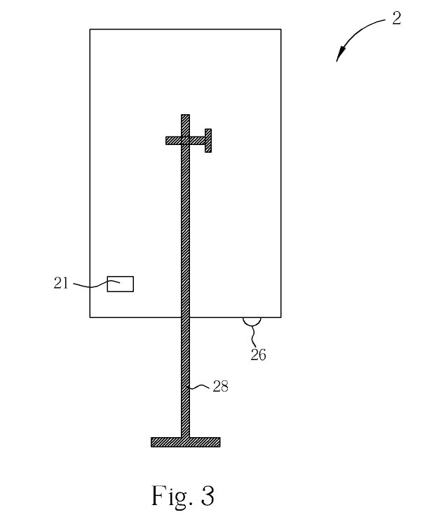

Please refer to FIG. 2 and FIG. 3, which are a front view and a rear view of a light box 2 of the present invention, respectively. The light box 2 comprises a light-pervious plate 22, a plurality of light sources 24, a power switch 26, a power socket 21, and a support 28. The support 28 comprises an adjustable mechanism to adjust the height of the light box 2. The light source 24 can be a light bulb or a light tube, such as a fluorescent tube or a cold cathode tube. The color of the light-pervious plate 22 can be only one color or can be multicolored. When turning on the light source 24, colorful background light is provided.

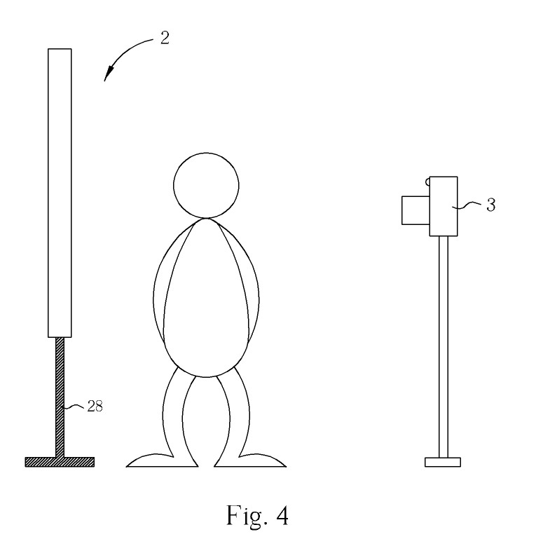

Please refer to FIG. 4, which shows how photographic equipment is arranged based on the present invention. The photographic equipment required by the present invention comprises a camera 3 with a flash and a light box 2. The light source 24 of the light box 2 is turned on. When a person to be photographed sits between the light box 2 and the camera 3, the flash of the camera 3 is started and the camera 3 focuses on the person to be photographed to take a picture of the person.

The present invention utilizes the light box 2 to provide background light so as to eliminate shadow resulting from the flash of the camera 3. The present invention does not have to set the flash synchronizer 14, and thereby the camera 3 that the present invention uses is not required to be a professional camera, like a single-lens reflex (SLR) camera. Other cameras, such as a point-and-shoot camera, a digital camera, or a traditional camera using negatives, can be used with the light box 2 of the present invention to take photos without shadow.

The present invention provides a method for avoiding generating shadow when taking a picture. The photographic equipment of the present invention is not expensive, and does not require a professional photographer to operate. Anyone can take ID photos without shadow with a camera having a flash and a light box of the present invention. Additionally, the present invention does not require a wider space to arrange flashes.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for avoiding generating shadow when taking a picture of an object, the method comprising:
setting up a camera;
setting up a light box in front of the camera;
turning on the light box; and
turning on a flash of the camera and pushing a shutter button of the camera when an objected to be photographed is positioned between the camera and the light box.

2. The method of claim 1, wherein setting up the camera comprises setting up a point-and-shoot camera, a digital camera, a traditional camera using negatives, or a single-lens reflex camera.

3. The method of claim 1, wherein turning on the light box comprises turning on a plurality of light tubes of the light box.

4. The method of claim 3, wherein turning on the plurality of light tubes of the light box comprises turning on a plurality of fluorescent tubes of the light box.

5. The method of claim 3, wherein turning on the plurality of light tubes of the light box comprises turning on a plurality of cold cathode tubes of the light box.

6. The method of claim 1, wherein turning on the light box comprises turning on a plurality of light bulbs of the light box.

7. The method of claim 1, wherein setting up the light box comprises setting up a light box emitting monochromatic light.

8. The method of claim 1, wherein setting up the light box comprises setting up a light box emitting multicolored light.

9. The method of claim 1 further comprising adjusting a height of the light box.

10. The method of claim 1 further comprising focusing the camera on the object to be photographed.
